(19) United States
(12) Patent Application Publication
(10) Pub. No.: US 2015/0250254 A1
(43) Pub. Date: Sep. 10, 2015

(54) LIFESAVING DEVICE WITH PROTECTIVE HELMET AND OXYGEN SUPPLY

(71) Applicant: Martina HUBER, Wien (AT)

(72) Inventor: Martina Huber, A-1010 Vienna (AT)

(21) Appl. No.: 14/438,867

(22) PCT Filed: Oct. 23, 2013
(86) PCT No.: PCT/AT2013/000179

§ 371 Date: Apr. 27, 2015

(30) Foreign Application Priority Data
Oct. 30, 2012 (AT) A 1168/2012

(51) Int. Cl. A42B 3/28; A62B 9/02; A62B 9/06; A62B 7/02

(52) U.S. Cl. CPC A42B 3/288; A62B 7/02; A62B 9/022; A62B 9/06

(57) ABSTRACT

Lifesaving device, for use in boats, in particular sports boats, consisting substantially of an open helmet (1) with an integrated mouthpiece (7), respiration tubes (2) and a respiration controller (3), which are connected to an oxygen tank (12) that is carried on the person's body or detachably connected to the boat, characterized in that the mouthpiece (7) has a guard (8).

### TECHNICAL FIELD

The invention concerns a lifesaving device to be used in water in the form of a water sports helmet with oxygen supply.

### BACKGROUND

A safety risk in water sports, particularly in paddling, are cases when a paddler's head goes underwater due to capsizing the boat and the paddler can neither right the boat within seconds nor reach the surface. The most common causes for such cases are that the capsized boat has been trapped in eddying currents or wedged between rocks.

Even if the paddler has followed Rule Number 1—never paddle alone—the paddler will only have 1½-2 minutes before brain damage due to lack of oxygen sets in and drowning may occur. In such a short time span, accompanying companions often do not succeed in reaching the scene of the accident, securing themselves and rescuing the accident victim, which frequently leads to tragedy.

### SUMMARY

The purpose of this invention is to save people from such an accidental death. The disclosed lifesaving device comprises an open water sports helmet with an integrated mouthpiece and connected oxygen bottle carried on the paddler's person or mounted on the boat.

Additional features and advantages of the invention can be seen from the following description and illustration describing a preferred configuration of the invention using examples.

### BRIEF DESCRIPTION OF THE DRAWINGS

FIG. 1-3 show full views of the helmet with the integrated mouthpiece according to the invention (in various exemplary configurations);

FIGS. 2(b) and 2(c) show cross-sections of the helmet with the integrated mouthpiece;

FIGS. 4 and 5 show schematics of the lifesaving device in the configuration preferred for the invention.

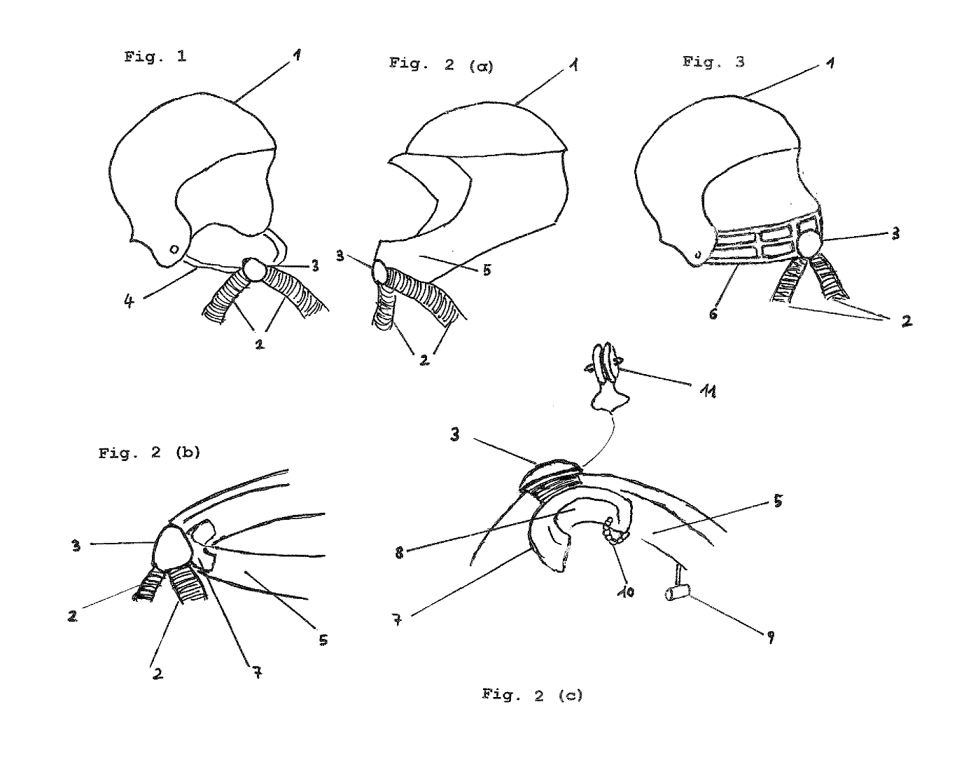

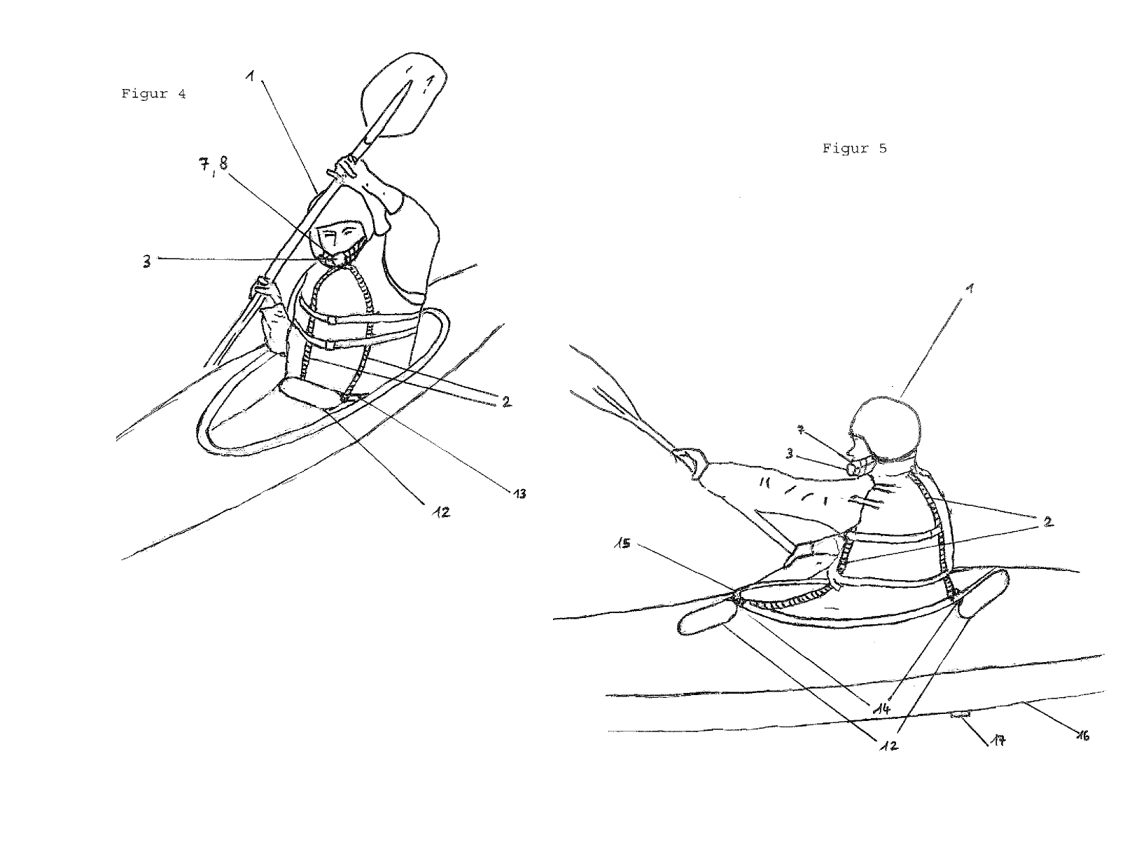

### DETAILED DESCRIPTION

Whereas standard open water sports helmets only protect against impacts, the innovative “Aquatic Sports Rescue Helmet” presented here also provides the function of an oxygen supply using a mouthpiece integrated into the helmet. There are different ways for integrating the mouthpiece into the helmet.

Whereas FIG. 1 shows a full-cut helmet 1 with the mouthpiece 7 integrated into the buckle-on belt 4 of the helmet 1, FIG. 2 shows a full-face helmet 1 with the mouthpiece 7 integrated directly into the helmet frame 5, and FIG. 3 shows a full-cut helmet 1 with an attachable mask 6 with the mouthpiece 7 integrated into the mask 6.

The mouthpiece 7 is thus positioned directly in front of the mouth of the distressed person, which is of significant importance.

Since everything must function quickly and simply when people are getting in emergency and panic situations, triggering the oxygen supply happens as shown in FIG. 2(c) in the following way:
Biting the guard 8 of the mouthpiece 7, or
Pressing the tip of the tongue to open the guard 8 of the mouthpiece 7, or
Poss. by using a ripcord mechanism instead of mouth movement to activate the oxygen supply, which is operated manually by pulling a ripcord a few centimeters long 9 attached to the lower helmet frame 5, which releases the guard 8 of the mouthpiece 7 and activates the oxygen supply. Though, one must keep in mind that, in rare cases, the paddler's arms may be trapped, which makes the first two options the safer solutions.

The guard 8 of the mouthpiece 7 consists of a small plastic plate and is secured by an extremely short metal chain just a few millimeters long, so that taking a deep breath will not allow it to enter the sportsman's throat. In the case that the kayaker is not anyway habitually using a nose clip 11, there is for emergency situations in any case a nose clip 11 mounted on the mouthpiece 7 using a heavy-gage, flexible connecting wire.

In accordance with the current state of the art, the breathing tubes 2 are connected with the mouthpiece 7 using valves that open in opposite directions and the mouthpiece 7 is equipped with protection valves (AquaStop) and/or an air shower, so that water from the paddler's mouth cannot enter the breathing tubes 2.

The mouthpiece 7, regulator 3 and breathing tubes 2 are, in accordance with the state of the art, also suitable for low water temperatures (coldwater resistant).

In order to avoid restricting the sportsman's mobility (such as when using paddles), both tubes 2 are kept tight against the upper body, which is easily possible through the routinely worn life jacket and its fasteners (FIG. 4).

Depending on the kind of waters preferred by the paddler and the average rescue duration to be taken into consideration, the helmet 1 is provided with different oxygen supply variants:

Because the pressure amounts to 0.10 to 0.15 bar when the head of a person is upside down in a water depth of 1 to 1.5 meters, a small dimensioned bottle 12 can be used. Hence, the helmet can be combined with a pony bottle (2 to 4 liters), a stage of similar capacity or spare air. In order to encounter low water temperatures and the danger of the formation of ice, a mono bottle with double valve is to be considered.

The stability of the boat will not be affected by such a low weight of the oxygen bottle 12 (2 to 4 kg). In any event, the bottle 12 will be attached centrally to the boat. There are three options for this:
Ideally, the bottle 12 is carried by a belt 13 around the abdomen (FIG. 4).
the bottle 12 may also be inserted into an aluminum frame 14 attached either in front of or
behind the paddler at the entry hatch 15 (FIG. 5)

As an additional safety precaution, an acoustic alarm siren (17) of at least 95 dB mounted on the keel of the boat is activated automatically by a radio signal the same moment when the sportsman is making use of the oxygen supply, which will indicate the sportsman's emergency status so that he can be located by the sound.

The invention is not limited to the example for carrying out the invention as depicted and described, but there are several modifications and additions conceivable without leaving the scope of the invention. Hence, use of the lifesaving device according to the invention is, for example, not merely limited to boats and sport boats, in particular, but is in general conceivable on inland waters or at sea.

1.-16. (canceled)

17. A lifesaving device for use in water sports, comprising:
an open helmet with an integrated mouthpiece;
a regulator arranged at and operatively connected to the integrated mouthpiece;
a breathing tube connecting the regulator with an oxygen supply; and
a guard which normally seals the mouthpiece and prevents oxygen from flowing through the mouthpiece,
wherein the guard can be opened in case of an emergency to allow oxygen to flow through the mouthpiece.

18. The lifesaving device as in claim 17, wherein the integrated mouthpiece is arranged on the helmet such that it is directly in front of the mouth of a person wearing the helmet.

19. The lifesaving device as in claim 18, wherein the integrated mouthpiece is part of a buckle-on belt or a helmet frame or a mask.

20. The lifesaving device as in claim 17, wherein the guard comprises a plastic plate.

21. The lifesaving device as in claim 17, wherein the guard can be opened by a user biting thereon.

22. The lifesaving device as in claim 17, wherein the guard can be opened by a user pushing the guard with the tip of the user's tongue.

23. The lifesaving device as in claim 17, further comprising a ripcord attached to the helmet for releasing the guard and activating the flow of oxygen.

24. The lifesaving device as in claim 17, further comprising by a metal chain connected to the guard.

25. The lifesaving device as in claim 17, wherein the mouthpiece comprises a protection valve and/or an air shower to prevent water from entering the breathing tube.

26. The lifesaving device as in claim 17, further comprising a nose clip flexibly connected to the mouthpiece.

27. The lifesaving device as in claim 17, further comprising an exhalation tube connected to the mouthpiece, wherein the breathing tube and the exhalation tube comprise valves opening in opposite direction.

28. The lifesaving device as in claim 17, wherein the breathing tube is connected to the regulator and to the oxygen supply by detachable connections.

29. The lifesaving device as in claim 17, wherein the oxygen supply is an oxygen bottle worn on a user's body or detachably mounted to a boat.

30. The lifesaving device as in claim 29, wherein the oxygen bottle is attached to the user's body by a belt.

31. The lifesaving device as in claim 29, wherein the oxygen bottle is attached to an aluminum frame hung either in front of or behind an entry hatch of a kayak.

32. The lifesaving device as in claim 29, wherein by the oxygen bottle is a pony bottle, a stage, or spare air.

33. The lifesaving device as in claim 17, wherein the mouthpiece, the regulator, the breathing tubes and the oxygen supply are suitable to operate in cold water.

34. The lifesaving device as in claim 33 wherein the oxygen supply comprises a double valve.

35. The lifesaving device as in claim 17, further comprising an acoustic alarm siren of at least 95 dB mounted on the keel of a boat, wherein the alarm siren is activated automatically when oxygen flows through the mouthpiece.
